(19) United States
(12) Patent Application Publication
(10) Pub. No.: US 2013/0325407 A1
(43) Pub. Date: Dec. 5, 2013

(54) APPARATUS AND METHOD FOR SHARING SENSING INFORMATION OF PORTABLE DEVICE

(71) Applicant: Electronics and Telecommunications Research Institute, (US)

(72) Inventor: Hyung-Seok LEE, Daejeon (KR)

(73) Assignee: Electronics and Telecommunications Research Institute, Daejeon (KR)

(21) Appl. No.: 13/731,304

(22) Filed: Dec. 31, 2012

(30) Foreign Application Priority Data
May 31, 2012 (KR) 10-2012-0058199

(51) Int. Cl. G06F 17/00

(52) U.S. Cl. CPC G06F 17/00
USPC 702/188

(57) ABSTRACT

Disclosed herein is an apparatus and method for sharing sensing information of a portable device. The apparatus includes a sensor control unit for collecting sensing information sensed by sensors. A communication control unit collects sensing information from peripheral devices. An information management unit stores the collected sensing information. An information collection unit determines a sensing information collection range based on a sensing information request from an application and a sensing information collection policy, receives the sensing information from at least one of the sensor control unit, the communication control unit, and the information management unit based on the determined sensing information collection range, converts the received sensing information into a format requested by the application based on the sensing information request, and transmits the converted information to the application.

### CROSS REFERENCE TO RELATED APPLICATION

This application claims the benefit of Korean Patent Application No. 10-2012-0058199, filed on May 31, 2012, which is hereby incorporated by reference in its entirety into this application.

### BACKGROUND OF THE INVENTION

1. Technical Field

The present invention relates generally to an apparatus and method for sharing the sensing information of a portable device and, more particularly, to an apparatus and method for sharing the sensing information of a portable device, which collect various types of surrounding environmental information based on various sensor functions and a portable device capable of searching the surroundings and performing communication and which share the collected information.

2. Description of the Related Art

With the development of technology, various types of portable devices have been developed and popularized. Examples of portable devices include smart phones which have recently become more and more popularized or multimedia devices which provide various types of multimedia functions.

Such a portable device is fundamentally provided with a Global Positioning System (GPS) function and a camera function, and includes therein a plurality of sensors to provide various types of services. In detail, such a portable device is provided with a GPS sensor for providing a location-based service, such as a navigation service, an illuminance sensor for changing the settings of the portable device depending on the surrounding environment, a geomagnetic sensor for providing games or location-based services, a gravity (acceleration) sensor, a gyro sensor, etc.

Thanks to the development of Micro Electro Mechanical Systems (MEMS) technology, as technology for various low-priced and small-sized sensors has been developed, it is expected that in the future, various sensors for measuring the five senses, the environment (ultraviolet rays or contaminants), motion recognition, etc. will be mounted. Together with such sensors, various types of communication means capable of communicating with peripheral devices, such as for Bluetooth, Zigbee, Wireless Fidelity (Wi-Fi) Peer-to-Peer (P2P), or Dash7, are mounted on portable devices including smart phones.

Prior technology related to the provision of services using a plurality of sensors installed on a portable device includes technology disclosed in Korean Patent Application Publication No. 10-2011-0097605 (entitled “System and method for automatically configuring a user terminal”). This technology analyzes the location, space, motion direction and motion status of a user, and automatically sets and recovers the configuration of the mobile phone of the user to match the user's situation. The prior technology presents a method of recognizing the location, space, and motion of the user using multiple sensors, defining the configuration information of the user terminal matching the situation, and automatically changing and setting the configuration information of the user terminal in conjunction with the user terminal, thus providing an etiquette service in public places, such as an office, a classroom, a conference room, a theater, an airplane, a vehicle, and a hospital, and a green environment construction service (noise prevention, traffic accident prevention, the blocking of jamming in important facilities, energy conservation using battery power saving, etc.).

However, the prior technology is problematic in that the sensors are limitedly used in such a way as to utilize information, obtained from sensors mounted on a portable device, for the applications of the portable device itself, thus causing services using the sensing information to be limited.

### SUMMARY OF THE INVENTION

Accordingly, the present invention has been made keeping in mind the above problems occurring in the prior art, and an object of the present invention is to provide an apparatus and method for sharing the sensing information of a portable device, which collect various types of surrounding environmental information based on various sensor functions and a portable device capable of searching the surroundings and performing communication, thus providing various types of application services. That is, the present invention is intended to collect sensor information in real time from other terminals or devices, located locally or remotely, by using various communication functions of the portable device, and provide various types of application services using the collected sensing information.

Another object of the present invention is to provide an apparatus and method for sharing the sensing information of a portable device, which minimize the power loss of the portable device caused by the sharing of sensing information, thereby considering low power consumption and high efficiency.

In accordance with an aspect of the present invention to accomplish the above objects, there is provided an apparatus for sharing sensing information of a portable device, including a sensor control unit for collecting sensing information sensed by sensors; a communication control unit for collecting sensing information from peripheral devices; an information management unit for storing the collected sensing information; and an information collection unit for determining a sensing information collection range based on a sensing information request from an application and a sensing information collection policy, receiving the sensing information from at least one of the sensor control unit, the communication control unit, and the information management unit based on the determined sensing information collection range, converting the received sensing information into a format requested by the application based on the sensing information request, and transmitting the converted information to the application.

Preferably, the apparatus may further include one or more application processing units for transmitting a sensing information request to the information collection unit, and providing a service based on information received from the information collection unit.

Preferably, the apparatus may further include a policy management unit for storing and managing policies on collection and transmission of the sensing information.

Preferably, the policy management unit may store and manage policies including at least one of a sensing information collection policy, a power management policy, an information supplementation policy, and a communication mode change policy.

Preferably, the information collection unit may determine at least one of collection of sensing information using sensors, collection of sensing information from peripheral terminals, and collection of pre-stored sensing information to fall within the sensing information collection range, based on the sensing information request and the sensing information collection policy.

Preferably, the information collection unit may transmit a sensing information collection request to the sensor control unit if collection of sensing information using sensors is determined to fall within the sensing information collection range, and the sensor control unit may drive at least one of a plurality of sensor modules in response to the sensing information collection request, and then collect sensing information.

Preferably, the information collection unit may transmit a sensing information collection request to the communication control unit if collection of sensing information from peripheral terminals is determined to fall within the sensing information collection range, and the communication control unit may drive at least one of a plurality of communication modules in response to the sensing information collection request, and then collect sensing information from the peripheral terminals.

Preferably, the communication control unit may be configured to drive a communication module corresponding to a preset basic search communication mode, and search for a peripheral terminal capable of providing sensing information requested by the information collection unit, and if no peripheral terminal is found or if sensing information requested by the information collection unit is not received from a found peripheral terminal, change the basic search communication mode to another communication mode, and re-search for a peripheral terminal.

Preferably, the communication control unit may change the basic search communication mode based on a communication mode change policy including a change sequence of communication modes upon re-searching for a peripheral terminal.

Preferably, the information collection unit may transmit a sensing information detection request to the information management unit if collection of pre-stored sensing information is determined to fall within the sensing information collection range, and the information management unit may detect sensing information corresponding to the request from the pre-stored sensing information, and then transmit the detected sensing information to the information collection unit.

In accordance with another aspect of the present invention to accomplish the above objects, there is provided a method of sharing sensing information of a portable device, including receiving, by an information collection unit, a sensing information request from an application; determining, by the information collection unit, a sensing information collection range based on the sensing information request and a sensing information collection policy; requesting, by the information collection unit, sensing information from at least one of a sensor control unit, a communication control unit, and an information management unit; receiving, by the information collection unit, sensing information from at least one of the sensor control unit and the communication control unit; and converting, by the information collection unit, the received sensing information based on the sensing information request and transmitting converted sensing information to the application.

Preferably, the method may further include transmitting, by an application processing unit, a sensing information request to the information collection unit; receiving, by the application processing unit, sensing information from the information collection unit; and providing, by the application processing unit, a service based on the received sensing information.

Preferably, the determining the sensing information collection range may be configured such that the information collection unit determines at least one of collection of sensing information using sensors, collection of sensing information from peripheral terminals, and collection of pre-stored sensing information, to fall within the sensing information collection range, based on the sensing information request and the sensing information collection policy.

Preferably, the requesting the sensing information may be configured such that the information collection unit transmits a sensing information collection request to the sensor control unit if collection of sensing information using sensors is determined to fall within the sensing information collection range.

Preferably, the method may further include driving, by the sensor control unit, at least one of a plurality of sensor modules in response to the sensing information collection request, and then collecting sensing information; and transmitting, by the sensor control unit, the collected sensing information to the information collection unit.

Preferably, the requesting the sensing information may be configured such that the information collection unit transmits a sensing information collection request to the communication control unit if collection of sensing information from peripheral terminals is determined to fall within the sensing information collection range.

Preferably, the method may further include driving, by the communication control unit, at least one of a plurality of communication modules in response to the sensing information collection request, and then collecting sensing information from peripheral terminals; and transmitting, by the communication control unit, the collected sensing information to the information collection unit.

Preferably, the collecting the sensing information from the peripheral terminals may include driving, by the communication control unit, a communication module corresponding to a preset basic search communication mode and searching for communication-executable peripheral terminals; and searching, by the communication control unit, found peripheral terminals for a peripheral terminal capable of providing sensing information requested by the information collection unit.

Preferably, the collecting the sensing information from the peripheral terminals may further include changing, by the communication control unit, the basic search communication mode to another communication mode, and re-searching for a peripheral terminal if no peripheral terminal is found at the searching for peripheral terminals or if sensing information requested by the information collection unit is not received from a found peripheral terminal, and the re-searching the peripheral terminal may be configured such that the communication control unit changes the basic search communication mode based on a communication mode change policy including a change sequence of communication modes.

Preferably, the requesting the sensing information may be configured such that the information collection unit transmits a sensing information detection request to the information management unit if collection of pre-stored sensing information is determined to fall within the sensing information collection range.

According to the present invention, the apparatus and method for sharing the sensing information of the portable device are advantageous in that they share sensing information collected using sensors mounted on the portable device and sensing information collected from peripheral terminals, so that the apparatus and method can be utilized in various applications, such as traffic conditions, environmental monitoring, and disasters/calamities, unlike prior technology that uses only the information of sensors mounted on the portable device, and in that various types of target marketing or user-customized services can be provided in conjunction with Social Network Services (SNS) or the like.

Further, the apparatus and method for sharing the sensing information of the portable device are advantageous in that sensing information collected using sensors mounted on the portable device and sensing information collected from the peripheral terminals are shared, so that a large amount of sensing information, such as area information, for example, weather and temperature, is arranged into a large-capacity database, thus providing various services to the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an apparatus for sharing the sensing information of a portable device according to an embodiment of the present invention;

FIG. 2 is a block diagram showing an apparatus for sharing the sensing information of a portable device according to an embodiment of the present invention;

FIG. 3 is a block diagram showing the sensor control unit of FIG. 2;

FIG. 4 is a block diagram showing the communication control unit of FIG. 2;

FIG. 5 is a block diagram showing the information management unit of FIG. 2;

FIG. 6 is a flowchart showing a method of sharing the sensing information of a portable device according to an embodiment of the present invention;

FIG. 7 is a flowchart showing the sensing information collection step of FIG. 6;

FIG. 8 is a flowchart showing the sensing information collection step performed using the communication control unit of FIG. 7; and

FIG. 9 is a flowchart showing the sensing information collection step performed using the sensor control unit of FIG. 7.

### DESCRIPTION OF THE PREFERRED EMBODIMENTS

Preferred embodiments of the present invention will be described in detail below with reference to the accompanying drawings to such an extent that those skilled in the art can easily implement the technical spirit of the present invention. Reference now should be made to the drawings, in which the same reference numerals are used throughout the different drawings to designate the same or similar components. In the following description, redundant descriptions and detailed descriptions of known elements or functions that may unnecessarily make the gist of the present invention obscure will be omitted.

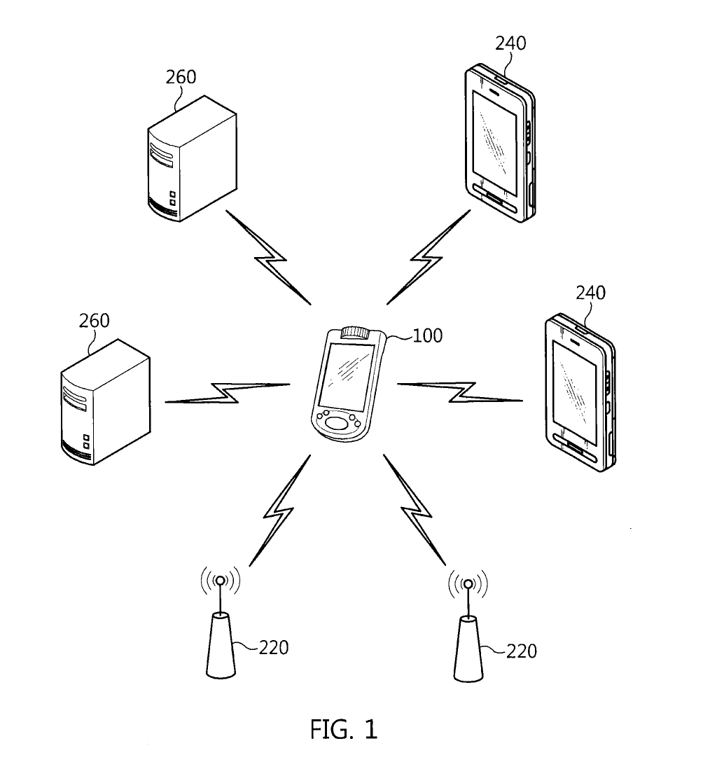

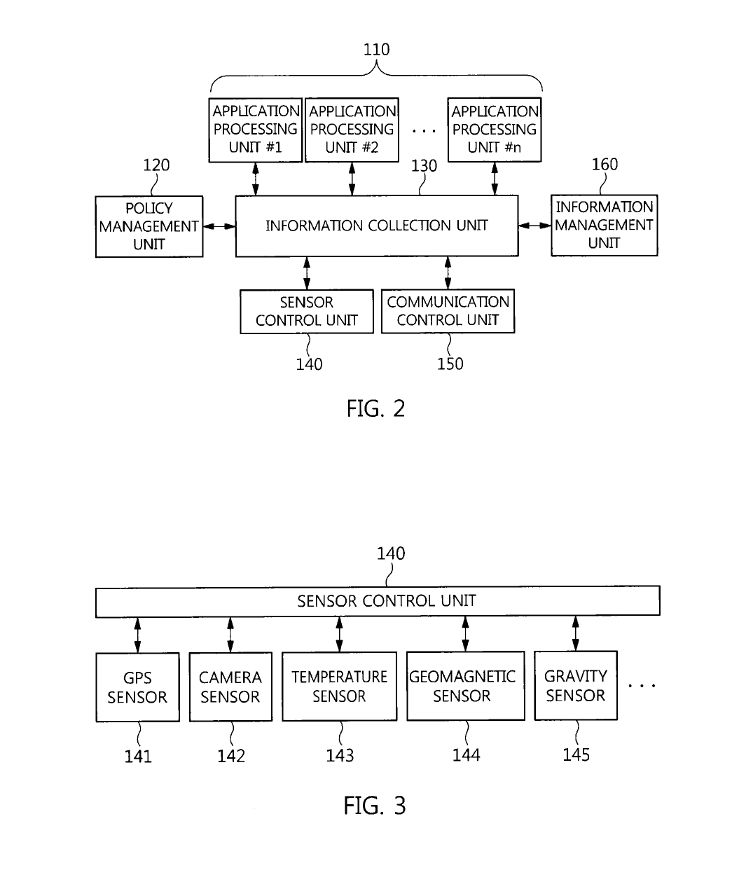

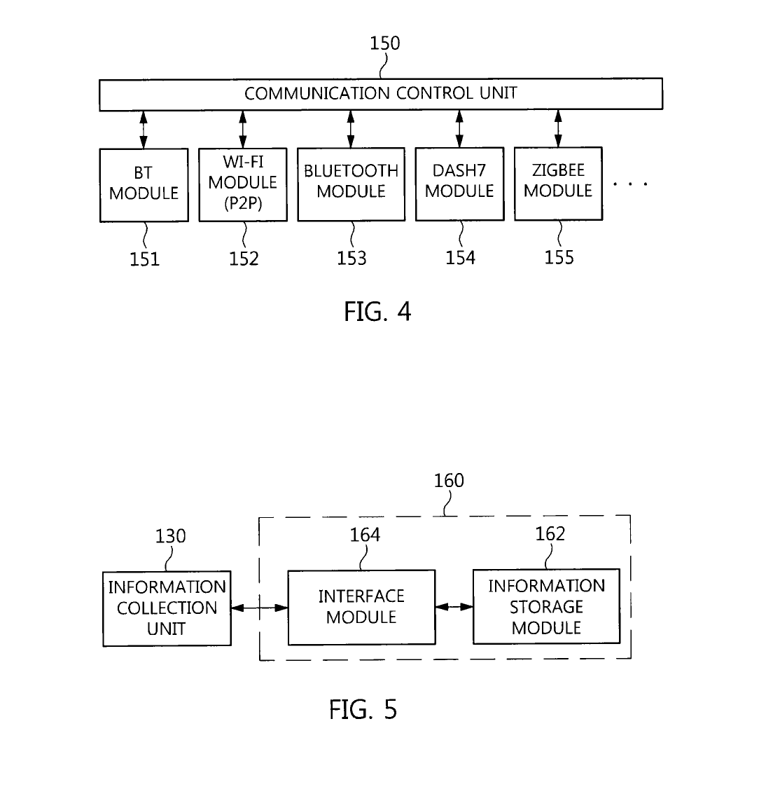

Hereinafter, an apparatus for sharing the sensing information of a portable device according to embodiments of the present invention will be described in detail with reference to the attached drawings. FIG. 1 is a diagram showing an apparatus for sharing the sensing information of a portable device according to an embodiment of the present invention, and FIG. 2 is a block diagram showing an apparatus for sharing the sensing information of a portable device according to an embodiment of the present invention. FIG. 3 is a block diagram showing the sensor control unit of FIG. 2, FIG. 4 is a block diagram showing the communication control unit of FIG. 2, and FIG. 5 is a block diagram showing the information management unit of FIG. 2.

As shown in FIG. 1, an apparatus 100 for sharing the sensing information of a portable device transmits and receives sensing information to and from peripheral terminals that are locally arranged. In FIG. 1, the portable device sensing information sharing apparatus 100 is shown as an independent portable device, but is not limited thereto and may be contained in a portable device, such as a smart phone, in the form of a module.

The portable device is equipped with communication modules, such as for mobile communication BT, Bluetooth, Wi-Fi, Near-Field Communication (NFC), Dash7, and Zigbee, so as to transmit and receive sensing information to and from the peripheral terminals. Here, the peripheral terminals are direct communication means, such as for BT, Wi-Fi P2P, and Dash7, and denote devices capable of communicating with the portable device sensing information sharing apparatus 100. The peripheral terminals sharing sensing information with the portable device include other peripheral portable devices 240, peripheral sensor devices 220 (including a sensor network), servers 260 at remote locations over the Internet, etc. Here, the servers 260 may include an information collection server 260 and an information provision server 260 on an external network.

Two-way communication is performed between the portable device and the peripheral terminals. That is, the portable device requests sensing information from the peripheral terminals, and receives sensing information collected by the peripheral terminals. The portable device can transmit the sensing information collected by the portable device in response to the requests from the peripheral terminals. In this case, the sensing information can be asynchronously shared among the portable device and the peripheral terminals. That is, depending on the settings, specific sensing information can be transmitted in real time to a preset specific target (or can be received in real time from the specific target) at the same time that the sensing information is generated.

The portable device is equipped with sensors, such as a GPS, a camera, a microphone, a gravity sensor, a geomagnetic sensor, and a temperature sensor, so as to collect sensing information. The sensing information shared among the portable device sensing information sharing apparatus 100 and the peripheral terminals has attributes, such as a place, a time, a provider, an information type, an information purpose, capacity, importance, public nature, and security. The type of sensing information may basically include environmental information, such as the distance and location of a target, the temperature, humidity, noise, and human density of the surrounding environment of the target. The type of sensing information may vary according to the type of available sensors. For example, when sensors, for example, an ultraviolet ray sensor, a chemical material sensor, such as for radioactivity, and a rainfall sensor, are mounted on the portable device, or when the above sensors are present in the surroundings of the portable device, pieces of information collected by the respective sensors can be used as the sensing information. In addition, the information about pictures, video, and audio that can be collected by the camera and the microphone may be a target of information. Speech recognition and video recognition information that correspond to a secondarily processed form of the above information may be included in the sensing information.

The portable device sensing information sharing apparatus 100 requests sensing information from the peripheral terminals in response to information received from internal applications. Accordingly, the peripheral terminals that received the request transmit pieces of sensing information collected thereby to the portable device sensing information sharing apparatus 100. In this case, the peripheral terminals transmit the sensing information collected thereby to the portable device sensing information sharing apparatus 100.

The portable device sensing information sharing apparatus 100 transmits the sensing information collected by the contained sensors to other surrounding portable devices 240 in response to requests from the other portable devices 240. In this case, the portable device sensing information sharing apparatus 100 may transmit the sensing information collected by the peripheral terminals to other portable devices 240.

In this way, the portable device sensing information sharing apparatus 100 shares the sensing information by transmitting and receiving the sensing information to and from the peripheral terminals or other surrounding portable devices 240. The portable device sensing information sharing apparatus 100 performs application processing using the shared sensing information. That is, the portable device sensing information sharing apparatus 100 changes the sensing information shared with the peripheral terminals to a format corresponding to the application processing.

For this, as shown in FIG. 2, the sensing information sharing apparatus 100 includes a plurality of application processing units 110, a policy management unit 120, an information collection unit 130, a sensor control unit 140, a communication control unit 150, and an information management unit 160.

The application processing units 110 provide various types of services through the portable device based on the sensing information. In this case, the application processing units 110 can provide various types of services, so that a processing form is not limited, and an example thereof will now be described.

Each application processing unit 110 can provide a service for notifying a portable device user of an emergency that has occurred in the surroundings. The application processing unit 110 requests and receives sensing information from the information collection unit 130. In this case, the application processing unit 110 receives sensing information collected by the portable device itself, and sensing information collected by the peripheral terminals. When sensing information corresponding to an emergency (for example, a traffic accident, an explosion, etc.) is detected in the received sensing information, the application processing unit 110 notifies the user of the occurrence of the emergency by outputting text, sound, an image, or the like. In this case, the application processing unit 110 may transmit information about the occurrence of the emergency to the peripheral terminals. That is, the application processing unit 110 transmits information corresponding to the occurrence of an emergency to a specific peripheral terminal or a specific portable device in agreement with policies set by the policy management unit 120. Here, the application processing unit 110 may propagate the occurrence of an emergency to the surroundings via peripheral terminals or other portable devices 240 in a relay manner even if there is a limitation in communication coverage.

In another example, each application processing unit 110 can provide a meteorological information (or environmental information) collection service. That is, the application processing unit 110 collects environmental information using the sensors mounted on the portable device, and transmits the environmental information to the server 260. In this case, the application processing unit 110 detects environmental information, such as temperature and humidity, from pieces of sensing information received from the information collection unit 130, and transmits the detected environmental information to the server 260. The server 260 generates meteorological information or environmental information for a local area using the environmental information received from the respective sensing information sharing apparatuses 100 of the portable devices. The application processing unit 110 receives the meteorological information or environmental information of the local area from a specific server 260, and displays the received information.

The policy management unit 120 sets and manages various policies required to collect and transmit sensing information. In this case, the policy management unit 120 sets and manages policies which assign different attributes to applications, or which are applied in common to all applications, depending on the applications (that is, applications processed by the application processing unit 110). The policy management unit 120 manages policies that are set differently depending on the location and surrounding situation of the portable device, the operating state of the portable device (for example, a busy state, a video play state, etc.), the status of available power, etc. In this case, the policies managed by the policy management unit 120 are used as the basis of determination related to the collection and processing of sensing information by the information collection unit 130, the communication control unit 150, and the sensor control unit 140. That is, various policies, such as a sensing information collection policy, a power management policy, and an information supplementation policy (for example, a user information protection policy) that are managed by the policy management unit 120 and set by the user, are used as the basis of making political decisions at a specific time, together with the attributes of the sensing information (for example, an urgency level), situational information, etc.

The information collection unit 130 collects pieces of sensing information. That is, the information collection unit 130 requests the collection of sensing information from the communication control unit 150 or the sensor control unit 140. The information collection unit 130 receives pieces of sensing information collected by the peripheral terminals from the communication control unit 150 via the communication modules. The information collection unit 130 receives the pieces of sensing information collected using the sensors from the sensor control unit 140.

The information collection unit 130 collects sensing information whenever a sensing information request is received from the application processing unit 110. Of course, the information collection unit 130 can collect sensing information at preset periods in agreement with an information collection policy. In this case, the information collection unit 130 determines the range of collection of sensing information based on at least one of the request from the application processing unit 110 and the policies managed by the policy management unit 120. Here, the information collection unit 130 determines one of the collection of sensing information using sensors, the collection of sensing information by the peripheral terminals, and the collection of sensing information stored in the information management unit 160 to fall within the range of collection, on the basis of the request from the application processing unit 110 and the policies managed by the policy management unit 120. The information collection unit 130 can also determine two or more of the collection of sensing information using sensors, the collection of sensing information by the peripheral terminals, and the collection of sensing information stored in the information management unit 160 to fall within the range of collection. For example, the information collection unit 130 can collect sensing information by combining the collection of sensing information using a plurality of sensors with the collection of sensing information from the peripheral terminals. Here, the information collection unit 130 may incorporate information, such as the accuracy (time and error ranges) and urgency of information, and a preset power management policy, together with the request from the application processing unit 110 and the policy, into the determination of the collection range of sensing information.

The information collection unit 130 generates information having a format requested by the application processing unit 110 using the collected sensing information. That is, the information collection unit 130 generates information having a format, requested by the application processing unit 110, by combining or processing pieces of previously collected sensing information. The information collection unit 130 transmits the generated information to the application processing unit 110. Of course, the information collection unit 130 may transmit the generated information to the corresponding information management unit 160 and store it in the information management unit 160 so that the generated information is shared and used among the application processing units 110. In this case, when the information generated using the collected sensing information does not satisfy a requirement level requested by the application processing unit 110, the information collection unit 130 may change collection conditions depending on the set policy, and re-collect sensing information.

The sensor control unit 140 collects sensing information by controlling sensors mounted on the portable device in response to the request from the information collection unit 130. For this, as shown in FIG. 3, the sensor control unit 140 is connected to sensors mounted on the portable device, for example, a GPS sensor 141, a camera sensor 142, a temperature sensor 143, a geomagnetic sensor 144, and a gravity sensor 145. The sensor control unit 140 operates the connected sensors in response to the request from the information collection unit 130. Accordingly, the sensors sense pieces of corresponding information, and transmit the results of sensing as pieces of sensing information to the sensor control unit 140. The sensor control unit 140 transmits the pieces of sensing information received from the sensors to the information collection unit 130. In this case, the sensor control unit 140 can control a sampling period, collection time, etc. for information collection depending on the accuracy or urgency of the requested information.

The sensor control unit 140 selectively operates one or more specific sensors in response to the request from the information collection unit 130. Of course, the sensor control unit 140 can also operate all sensors in response to the request from the information collection unit 130 and transmit only pieces of sensing information corresponding to the request, from among the pieces of sensing information received from the sensors, to the information collection unit 13.

The communication control unit 150 controls communication modules to transmit and receive the sensing information. That is, the communication control unit 150 performs the search and collection of sensing information requested via the information collection unit 130, the transmission of collected information, and the processing of an information request message or an information transmission message that is externally applied.

The communication control unit 150 controls the communication modules mounted on the portable device in response to the request from the information collection unit 130, and then collects pieces of sensing information. For this, as shown in FIG. 4, the communication control unit 150 is connected to communication modules mounted on the portable device, such as a BT module 151, a Wi-Fi module 152, a Bluetooth module 153, a Dash7 module 154, and a Zigbee module 155. The communication control unit 150 drives the connected communication modules in response to a request from the information collection unit 130. Accordingly, the communication modules receive pieces of sensing information collected by the peripheral terminals while communicating with the peripheral terminals. The communication control unit 150 transmits the pieces of sensing information received from the communication modules to the information collection unit 130.

In this case, the communication control unit 150 selectively drives one or more communication modules in response to a request from the information collection unit 130. Of course, the communication control unit 150 can also drive all communication modules in response to a request from the information collection unit 130 and transmit only pieces of sensing information corresponding to the request, from among the pieces of sensing information received from the communication modules, to the information collection unit 130.

The communication control unit 150 determines whether peripheral terminals have been found by searching for peripheral terminals in order to collect sensing information requested by the information collection unit 130. That is, the communication control unit 150 determines whether peripheral terminals capable of providing sensing information corresponding to the request from the information collection unit 130 are present in the surroundings by searching the surroundings. In this case, the communication control unit 150 determines whether peripheral terminals have been found, based on the attributes of the sensing information requested by the information collection unit 130 and a preset policy.

The communication control unit 150 searches for peripheral terminals using a communication module corresponding to a basic search communication mode preset by the user among the communication modules. In this case, a communication module (for example, the Dash7 module) capable of performing communication even at low power is generally set as the communication module corresponding to the basic search communication mode.

The communication control unit 150 selects peripheral terminals capable of providing sensing information requested by the information collection unit 130 from among the found peripheral terminals. The communication control unit 150 collects pieces of sensing information from the selected peripheral terminals. For example, if information about the server 260 is included in the sensing information requested by the information collection unit 130, the communication control unit 150 determines that the sensing information collected by the server 260 has been found. The communication control unit 150 collects sensing information collected by the server 260 by driving the communication module.

In this case, the communication control unit 150 can set a communication module (that is, a communication mode) for collecting sensing information and a communication module (that is, a communication mode) used when performing the search, as different modules. For example, the communication control unit 150 can search for peripheral terminals via the Dash7 module 154 and receive the sensing information via the Wi-Fi module 152. In this case, the communication control unit 150 sets a communication module (or a communication mode) for collecting sensing information based on the attributes of response messages received from peripheral terminals upon searching for the peripheral terminals.

The communication control unit 150 determines suitability of sensing information collected by searching for peripheral terminals and sensing information collected in response to the request from the information collection unit 130. In this case, the communication control unit 150 determines that there is no suitability if collected sensing information is not present, or if sensing information corresponding to the request from the information collection unit 130 is not present. If it is determined that the suitability of the collected sensing information is not present, the communication control unit 150 performs additional collection or additional searching. That is, when all of the peripheral terminals are not set in the basic communication mode of the same communication mode so as to search for peripheral terminals, the communication control unit 150 cannot select the desired sensing information, and cannot perform searching even if peripheral terminals are present in the surroundings. In this case, the communication control unit 150 changes the basic communication mode for searching for peripheral terminals, and thereafter re-searches for peripheral terminals. The communication control unit 150 receives a communication mode change policy from the policy management unit 120. The communication control unit 150 changes the communication mode in agreement with the received communication mode change policy, and thereafter re-searches for peripheral terminals. Here, the communication mode change policy includes the change sequence of communication modes, is preset by the user, and is managed by the policy management unit 120.

The communication control unit 150 controls the driving of communication modules in agreement with the power management policy received from the policy management unit 120. That is, the communication control unit 150 activates only communication modules corresponding to the basic communication mode so as to minimize power consumption. The communication control unit 150 activates the remaining communication modules that are being in an inactivated state only when the remaining communication modules are required.

The communication control unit 150 may also transmit the collected sensing information to the peripheral terminals. That is, the communication control unit 150 may collect specific sensing information while transmitting the collected sensing information to the peripheral terminals, depending on the application processing unit 110 and the settings of the user. For example, when the transmission of emergency information is set depending on the settings of the user, the communication control unit 150 is configured to, if sensing information collected from the sensor control unit 140 or the peripheral terminals is emergency information, transmit collected sensing information (that is, the emergency information) to all peripheral terminals that can be searched for in the surroundings (that is, communication-executable peripheral terminals). In this case, the communication control unit 150 transmits the collected sensing information (that is, the emergency information) to the application processing unit 110 which processes the notification of occurrence of an emergency. Accordingly, the application processing unit 110 processes the occurrence of the emergency based on the received sensing information, and the application processing unit 110 transmits the sensing information to the peripheral terminals depending on the set policy by calling the communication control unit 150. In this case, the peripheral terminals process the occurrence of the emergency depending on pre-registered settings based on the sensing information corresponding to the emergency information received in the basic communication mode, and notify the user of the results of the processing. Thereafter, the peripheral terminals retransmit sensing information, which was previously received, to other peripheral terminals depending on the pre-registered settings. At this time, the communication control unit 150 performs filtering so as to prevent sensing information identical to the previously processed sensing information from being repeatedly received from the peripheral terminals.

The information management unit 160 stores the sensing information received from the information collection unit 130. That is, the information management unit 160 stores the sensing information received from the information collection unit 130 so that the sensing information is shared among the application processing units 110. In this case, the information management unit 160 detects and provides pre-stored sensing information in response to requests from the application processing units 110. By way of this operation, each application processing unit 110 can search for and reuse past sensing information after a predetermined period of time has elapsed, as well as sharing the sensing information. For this operation, as shown in FIG. 5, the information management unit 160 includes an information storage module 162 and an interface module 164. For information storage, pieces of sensing information received from the information collection unit 130 are stored in the form of a database (DB). The interface module 164 is connected to the information collection unit 130 to receive the sensing information from the information collection unit 130. The interface module 164 detects the sensing information requested by the information collection unit 130 from the information storage module 162, and transmits the detected sensing information to the information collection unit 130.

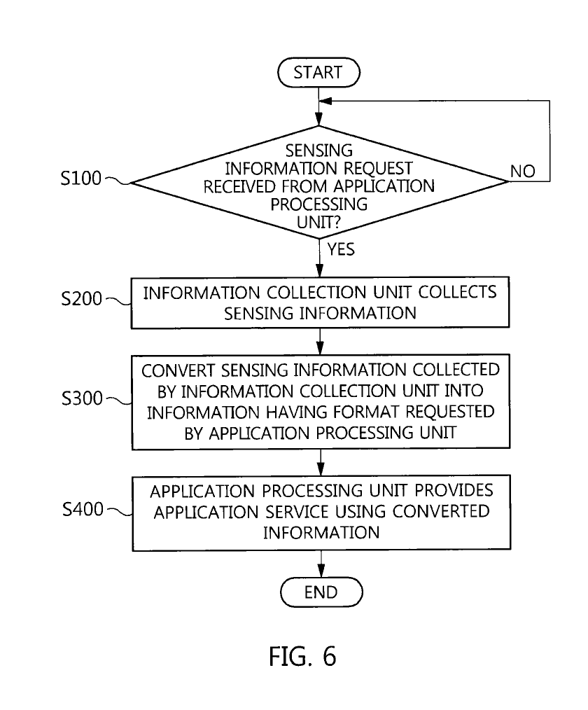

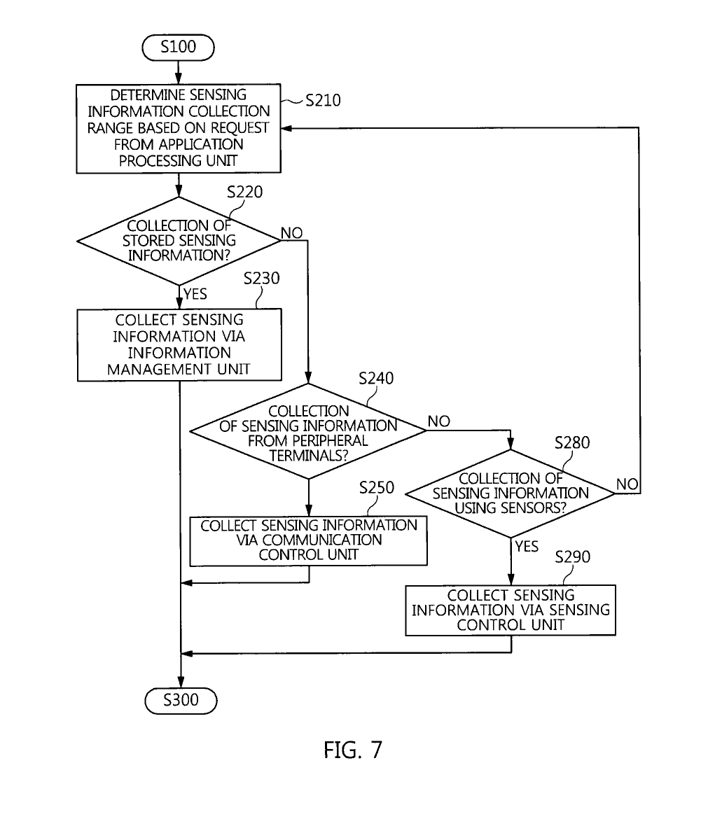

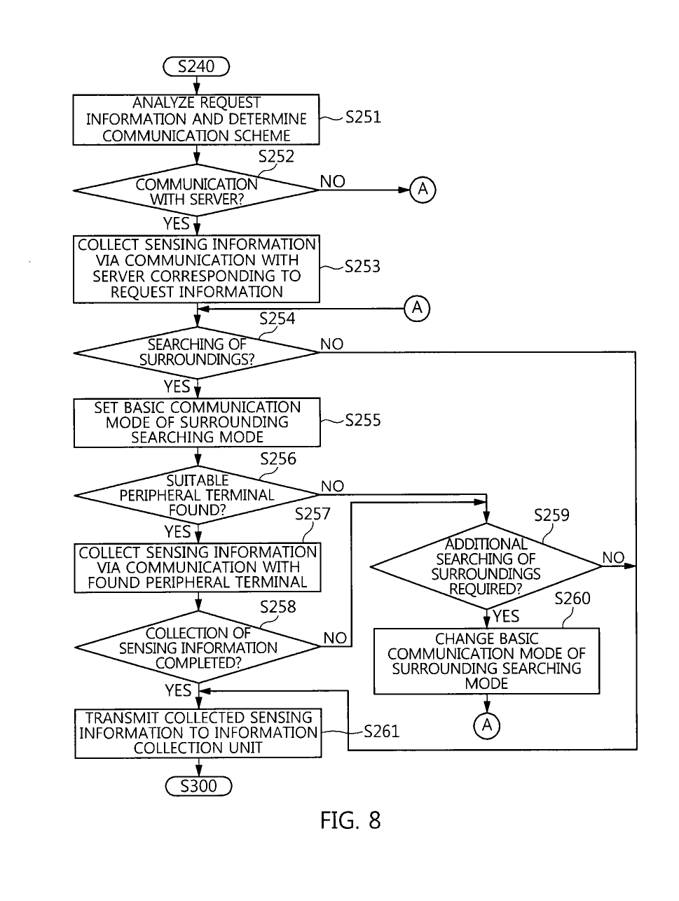

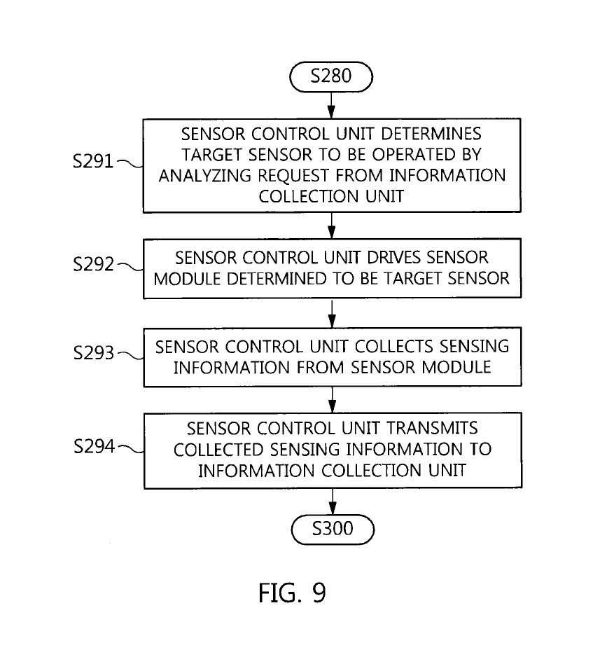

Hereinafter, a method of sharing the sensing information of a portable device according to an embodiment of the present invention will be described in detail with reference to the attached drawings. FIG. 6 is a flowchart showing a method of sharing the sensing information of a portable device according to an embodiment of the present invention, FIG. 7 is a flowchart showing the sensing information collection step of FIG. 6, FIG. 8 is a flowchart showing the sensing information collection step performed using the communication control unit 150 of FIG. 7, and FIG. 9 is a flowchart showing the sensing information collection step performed using the sensor control unit 140 of FIG. 7.

The application processing unit 110 provides various types of services using sensing information. For example, the services include a service for notifying a user of an emergency occurring in the surroundings, a meteorological information service, etc. The application processing unit 110 requests sensing information from the information collection unit 130 so as to provide a relevant service. When a sensing information request is received from the application processing unit 110 (in case of “Yes” at step S100), the information collection unit 130 collects pieces of sensing information corresponding to the request from the application processing unit 110 at step S200. That is, the information collection unit 130 collects pieces of sensing information requested by the application processing unit 110 using one of collection schemes, such as the collection of sensing information using the server 260, the collection of sensing information using the communication control unit 150, and the collection of sensing information using the sensor control unit 140, in response to the request from the application processing unit 110. This procedure will be described in greater detail with reference to FIG. 7.

The information collection unit 130 determines the range of collection of sensing information corresponding to the request from the application processing unit 110 at step S210. In this case, the information collection unit 130 determines at least one of the collection of stored sensing information, the collection of sensing information from the peripheral terminals, and the collection of sensing information using the sensors, to fall within the range of collection of sensing information, on the basis of the request from the application processing unit 110 and the policy from the policy management unit 120.

If the collection of stored sensing information (in case of “Yes” at step S220) is determined to fall within the sensing information collection range, the information collection unit 130 collects pieces of sensing information via the information management unit 160 at step S230. That is, the information collection unit 130 requests pre-stored sensing information from the information management unit 160. The information management unit 160 detects corresponding sensing information in response to the request from the information collection unit 130. The information management unit 160 transmits the detected sensing information to the information collection unit 130.

If the collection of sensing information from the peripheral terminals is determined to fall within the sensing information collection range (in case of “Yes” at step S240), the information collection unit 130 collects pieces of sensing information via the communication control unit 150 at step S250. This procedure will be described in greater detail with reference to FIG. 8.

The information collection unit 130 requests the communication control unit 150 to collect pieces of sensing information. The communication control unit 150 analyzes request information received from the information collection unit 130, and determines a communication scheme for collecting sensing information at step S251. In this case, the communication control unit 150 determines one of communication with the server 260 and communication based on the searching of the surroundings to be the communication scheme.

If communication with the server 260 has been determined (in case of “Yes” at step S252), the communication control unit 150 collects pieces of sensing information via communication with the server 260 corresponding to the request information at step S253. That is, the communication control unit 150 drives the Wi-Fi module 152 to communicate with the server 260 over the Internet. The communication control unit 150 accesses the server 260 via the Wi-Fi module 152 and requests sensing information from the server 260. The server 260 detects sensing information corresponding to the request from the communication control unit 150 and transmits the sensing information to the Wi-Fi module 152. The communication control unit 150 collects the sensing information received via the Wi-Fi module 152.

If communication based on the searching of the surroundings has been determined (in case of “Yes” at step S254), the communication control unit 150 sets the basic communication mode of a surrounding searching mode at step S255.

The communication control unit 150 searches the surroundings for a peripheral terminal capable of providing sensing information corresponding to the request from the information collection unit 130. In this case, the communication control unit 150 searches peripheral terminals based on the attributes of the sensing information requested by the information collection unit 130 and a preset policy. The communication control unit 150 determines whether a peripheral terminal suitable for the collection of sensing information has been found, based on the attributes of the sensing information requested by the information collection unit 130 and the preset policy.

If a suitable peripheral terminal has been found (in case of “Yes” at step S256), the communication control unit 150 selectively drives a communication module for communicating with the found peripheral terminal. The communication control unit 150 collects sensing information while communicating with the found peripheral terminal via the communication module at step S257.

If the collection of sensing information has been completed (in case of “Yes” at step S258), the communication control unit 150 determines whether additional searching of the surroundings is required at step S259. In this case, the communication control unit 150 determines the suitability of the sensing information collected by searching for the peripheral terminal, and the sensing information collected in response to the request from the information collection unit 130. The communication control unit 150 determines that there is no suitability if collected sensing information is not present, or if sensing information corresponding to the request from the information collection unit 130 is not present. If it is determined that the suitability of the collected sensing information is not present, the communication control unit 150 determines that additional collection or additional searching is required. That is, when all of the peripheral terminals are not set in the basic communication mode of the same communication mode so as to search for peripheral terminals, the communication control unit 150 cannot select the desired sensing information, and cannot perform searching even if peripheral terminals are present in the surroundings. In this case, the communication control unit 150 determines that additional searching of the surroundings is required.

If it is determined that the additional searching of the surroundings is required (in case of “Yes” at step S259), the communication control unit 150 changes the basic communication mode for searching for peripheral terminal at step S260. In this case, the communication control unit 150 receives a communication mode change policy from the policy management unit 120. The communication control unit 150 changes the communication mode in agreement with the received communication mode change policy, and thereafter re-searches for peripheral terminals. Here, the communication mode change policy includes the change sequence of communication modes, is preset by the user, and is managed by the policy management unit 120. Thereafter, the communication control unit 150 re-searches for peripheral terminals by performing steps S254 to S257.

The communication control unit 150 transmits the collected sensing information to the information collection unit 130 at step S261. In this case, the communication control unit 150 may also transmit the collected sensing information to the peripheral terminals. That is, the communication control unit 150 may collect specific sensing information while transmitting the specific sensing information to the peripheral terminals, depending on the application processing unit 110 and the settings of the user. For example, when the transmission of emergency information is set depending on the settings of the user, the communication control unit 150 is configured to, if sensing information collected from the sensor control unit 140 or the peripheral terminals is emergency information, transmit collected sensing information (that is, the emergency information) to all peripheral terminals that can be searched for in the surroundings (that is, communication-executable peripheral terminals). In this case, the communication control unit 150 transmits the collected sensing information (that is, the emergency information) to the application processing unit 110 which processes the notification of occurrence of an emergency. Accordingly, the application processing unit 110 processes the occurrence of the emergency based on the received sensing information, and the application processing unit 110 transmits the sensing information to the peripheral terminals depending on the set policy by calling the communication control unit 150. In this case, the peripheral terminals process the occurrence of the emergency depending on pre-registered settings based on the sensing information corresponding to the emergency information received in the basic communication mode, and notify the user of the results of the processing. Thereafter, the peripheral terminals retransmit sensing information, which was previously received, to other peripheral terminals depending on the pre-registered settings. At this time, the communication control unit 150 performs filtering so as to prevent sensing information identical to the previously processed sensing information from being repeatedly received from the peripheral terminals.

If the collection of sensing information using sensors is determined to fall within the sensing information collection range (in case of “Yes” at step S280), the information collection unit 130 collects sensing information via the sensor control unit 140 at step S290. This procedure will be described in greater detail with reference to FIG. 9.

The information collection unit 130 requests the sensor control unit 140 to collect sensing information. The sensor control unit 140 analyzes the request from the information collection unit 130 and determines a target sensor to be operated at step S291. In this case, the sensor control unit 140 determines at least one of various sensors, such as a GPS sensor, a camera sensor, a temperature sensor, a geomagnetic sensor, and a gravity sensor, which are mounted on the portable device, to be the target sensor to be operated.

The sensor control unit 140 drives a sensor module determined to be the target sensor at step S292. Accordingly, the driven sensor module senses the corresponding information. The sensor module transmits the results of sensing as sensing information to the sensor control unit 140.

The sensor control unit 140 collects the sensing information from the driven sensor module at step S293, and transmits the collected sensing information to the information collection unit 130 at step S294.

The information collection unit 130 converts the collected sensing information into information having a format requested by the application processing unit 110 at step S300. That is, the information collection unit 130 generates information having a format, requested by the application processing unit 110, by combining or processing pieces of previously collected sensing information. The information collection unit 130 transmits the generated information to the corresponding application processing unit 110. In this case, the information collection unit 130 may transmit the generated information to the information management unit 160 and store it in the information management unit 160 so that the generated information is shared and used among the application processing units 110. When the information generated using the collected sensing information does not satisfy a requirement level requested by the application processing unit 110, the information collection unit 130 may change collection conditions depending on the set policy, and re-collect sensing information.

The application processing unit 110 provides an application service using the information converted by the information collection unit 130 at step S400. For example, the application processing unit 110 notifies the user of the occurrence of an emergency by outputting text, sound or an image if information corresponding to the emergency (for example, a traffic accident, an explosion, etc.) has been detected in the information received from the information collection unit 130. In this case, the application processing unit 110 may transmit information about the occurrence of the emergency to the peripheral terminals. That is, the application processing unit 110 transmits information corresponding to the occurrence of an emergency to a specific peripheral terminal or a specific portable device in agreement with the policy set by the policy management unit 120. Here, the application processing unit 110 may propagate the occurrence of an emergency to the surroundings via peripheral terminals or other portable devices 240 in a relay manner even if there is a limitation in communication coverage.

As described above, the apparatus 100 and method for sharing the sensing information of the portable device are advantageous in that they share sensing information collected using sensors mounted on the portable device and sensing information collected from the peripheral terminals, so that the apparatus and method can be utilized in various applications, such as traffic conditions, environmental monitoring, and disasters/calamities, unlike prior technology that uses only the information of sensors mounted on the portable device, and in that various types of target marketing or user-customized services can be provided in conjunction with Social Network Services (SNS) or the like.

Further, the apparatus 100 and method for sharing the sensing information of the portable device are advantageous in that sensing information collected using sensors mounted on the portable device and sensing information collected from the peripheral terminals are shared, so that a large amount of sensing information, such as area information, for example, weather and temperature, is arranged into a large-capacity database, thus providing various services to the user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for sharing sensing information of a portable device, comprising:
a sensor control unit for collecting sensing information sensed by sensors;
a communication control unit for collecting sensing information from peripheral devices;
an information management unit for storing the collected sensing information; and
an information collection unit for determining a sensing information collection range based on a sensing information request from an application and a sensing information collection policy, receiving the sensing information from at least one of the sensor control unit, the communication control unit, and the information management unit based on the determined sensing information collection range, converting the received sensing information into a format requested by the application based on the sensing information request, and transmitting the converted information to the application.

2. The apparatus of claim 1, further comprising one or more application processing units for transmitting a sensing information request to the information collection unit, and providing a service based on information received from the information collection unit.

3. The apparatus of claim 1, further comprising a policy management unit for storing and managing policies on collection and transmission of the sensing information.

4. The apparatus of claim 3, wherein the policy management unit stores and manages policies including at least one of a sensing information collection policy, a power management policy, an information supplementation policy, and a communication mode change policy.

5. The apparatus of claim 1, wherein the information collection unit determines at least one of collection of sensing information using sensors, collection of sensing information from peripheral terminals, and collection of pre-stored sensing information to fall within the sensing information collection range, based on the sensing information request and the sensing information collection policy.

6. The apparatus of claim 1, wherein:
the information collection unit transmits a sensing information collection request to the sensor control unit if collection of sensing information using sensors is determined to fall within the sensing information collection range, and
the sensor control unit drives at least one of a plurality of sensor modules in response to the sensing information collection request, and then collects sensing information.

7. The apparatus of claim 1, wherein:
the information collection unit transmits a sensing information collection request to the communication control unit if collection of sensing information from peripheral terminals is determined to fall within the sensing information collection range, and
the communication control unit drives at least one of a plurality of communication modules in response to the sensing information collection request, and then collects sensing information from the peripheral terminals.

8. The apparatus of claim 7, wherein:
the communication control unit is configured to:
drive a communication module corresponding to a preset basic search communication mode, and search for a peripheral terminal capable of providing sensing information requested by the information collection unit, and
if no peripheral terminal is found or if sensing information requested by the information collection unit is not received from a found peripheral terminal, change the basic search communication mode to another communication mode, and re-search for a peripheral terminal.

9. The apparatus of claim 8, wherein the communication control unit changes the basic search communication mode based on a communication mode change policy including a change sequence of communication modes upon re-searching for a peripheral terminal.

10. The apparatus of claim 1, wherein:
the information collection unit transmits a sensing information detection request to the information management unit if collection of pre-stored sensing information is determined to fall within the sensing information collection range, and
the information management unit detects sensing information corresponding to the request from the pre-stored sensing information, and then transmits the detected sensing information to the information collection unit.

11. A method of sharing sensing information of a portable device, comprising:
receiving, by an information collection unit, a sensing information request from an application;
determining, by the information collection unit, a sensing information collection range based on the sensing information request and a sensing information collection policy;
requesting, by the information collection unit, sensing information from at least one of a sensor control unit, a communication control unit, and an information management unit;
receiving, by the information collection unit, sensing information from at least one of the sensor control unit, the communication control unit and the information management unit; and
converting, by the information collection unit, the received sensing information based on the sensing information request and transmitting converted sensing information to the application.

12. The method of claim 11, further comprising:
transmitting, by an application processing unit, a sensing information request to the information collection unit;
receiving, by the application processing unit, sensing information from the information collection unit; and
providing, by the application processing unit, a service based on the received sensing information.

13. The method of claim 11, wherein the determining the sensing information collection range is configured such that the information collection unit determines at least one of collection of sensing information using sensors, collection of sensing information from peripheral terminals, and collection of pre-stored sensing information, to fall within the sensing information collection range, based on the sensing information request and the sensing information collection policy.

14. The method of claim 13, wherein the requesting the sensing information is configured such that the information collection unit transmits a sensing information collection request to the sensor control unit if collection of sensing information using sensors is determined to fall within the sensing information collection range.

15. The method of claim 14, further comprising:
driving, by the sensor control unit, at least one of a plurality of sensor modules in response to the sensing information collection request, and then collecting sensing information; and
transmitting, by the sensor control unit, the collected sensing information to the information collection unit.

16. The method of claim 13, wherein the requesting the sensing information is configured such that the information collection unit transmits a sensing information collection request to the communication control unit if collection of sensing information from peripheral terminals is determined to fall within the sensing information collection range.

17. The method of claim 16, further comprising:
driving, by the communication control unit, at least one of a plurality of communication modules in response to the sensing information collection request, and then collecting sensing information from peripheral terminals; and
transmitting, by the communication control unit, the collected sensing information to the information collection unit.

18. The method of claim 17, wherein the collecting the sensing information from the peripheral terminals comprises:
driving, by the communication control unit, a communication module corresponding to a preset basic search communication mode and searching for communication-executable peripheral terminals; and
searching, by the communication control unit, found peripheral terminals for a peripheral terminal capable of providing sensing information requested by the information collection unit.

19. The method of claim 18, wherein:
the collecting the sensing information from the peripheral terminals further comprises changing, by the communication control unit, the basic search communication mode to another communication mode, and re-searching for a peripheral terminal if no peripheral terminal is found at the searching for peripheral terminals or if sensing information requested by the information collection unit is not received from a found peripheral terminal, and
the re-searching the peripheral terminal is configured such that the communication control unit changes the basic search communication mode based on a communication mode change policy including a change sequence of communication modes.

20. The method of claim 11, wherein the requesting the sensing information is configured such that the information collection unit transmits a sensing information detection request to the information management unit if collection of pre-stored sensing information is determined to fall within the sensing information collection range.
